(19) United States
(12) Patent Application Publication
(10) Pub. No.: US 2010/0073555 A1
(43) Pub. Date: Mar. 25, 2010

(54) IMAGE CAPTURE MODULE OF HANDHELD ELECTRONIC DEVICE WITH POLYDIRECTIONAL ROTATION FUNCTION

(76) Inventors: Shiao-Feng Li, Taipei (TW); Hung-Chang Hung, Taipei (TW); Po-Jen Ke, Taipei (TW)

Correspondence Address: Dr. BANGER SHIA, 102 Lindencrest Ct., Sugar Land, TX, 77479-5201, US

(21) Appl. No.: 12/542,658

(22) Filed: Aug. 17, 2009

(30) Foreign Application Priority Data
Sep. 22, 2008 (TW) 97136344

(51) Int. Cl. H04N 5/225

(52) U.S. Cl. 348/376; 348/E05.026

(57) ABSTRACT

An image capture module of a handheld electronic device is provided. In the image capture module, a spherical casing cooperates with a fixing cover and accommodates a camera module. The spherical casing is fixed in a casing of the electronic device by the fixing cover. Thus, the spherical casing can rotate transversely. In addition, the fixing cover has a slot to allow a connecting wire of the camera module to pass through, and thus, the spherical casing may rotate along the direction of the slot.

### BACKGROUND OF THE INVENTION

1. Field of Invention

The invention relates to an image capture module of a handheld electronic device and, more particularly, to an image capture module of a handheld electronic device having a built-in camera module with a simple structure and a wide angle and polydirectional rotation function.

2. Related Art

A handheld electronic device such as a mobile phone, a personal digital assistant (PDA) or a satellite position system is widely used nowadays. Taking the mobile phone as an example, most of the middle-level or high-level products have image capture modules. Since the PDA is relatively expensive, the image capture module becomes a basic component in the PDA. To the satellite position system, there is almost no product having a built-in image capture module, and there are just some designs for connecting an external one. A user needs to buy an external image capture module additionally to obtain the recording and photographing functions.

Generally, a handheld electronic device having a built-in image capture module has a fixed lens. The prior art discloses a handheld electronic device having a built-in rotary lens which uses a cylinder-shaped image capture module to achieve the rotating function. However, since the cylinder-shaped image capture module is embedded in the electronic device, the structure is complex. In addition, the shape of the cylinder only allows the lens to rotate around one axis, and the image capture angle is limited.

The cylinder-shaped casing in the prior art has a circle-shaped groove for rotating relative to the electronic device. This decreases the complexity of the structure greatly. However, since the basic rotation structure is unchangeable, the casing also may rotate relative to the electronic device around only one axis. Furthermore, since the casing is disposed at an edge of the handheld electronic device, it is easy to be collided and damaged.

Therefore, the lenses of the mobile phone and the PDA nowadays are not only complex in structure, but also limited greatly in rotation directions. Thus, the image capture angle is affected. In addition, although the satellite position system has relative software cooperating with it to record images when the vehicle is driven, since the image capture module is externally connected, it is inconvenient in usage.

### SUMMARY OF THE INVENTION

An image capture module of a handheld electronic device according to the invention includes a spherical casing, a camera module and a fixing cover. The spherical casing has an accommodating space and an image capture window communicating with the accommodating space. They are disposed in the casing of the handheld electronic device, and the image capture window corresponds to the assembling hole of the casing. The camera module is disposed in the accommodating space of the spherical casing, and it may capture outside images through the image capture window. The camera module has a connecting wire which may pass through the spherical casing to be electrically connected to the electronic device. The fixing cover is fixed to the spherical casing and supports the spherical casing, and a slot is located at the bottom to allow the connecting wire to pass through. The spherical casing may rotate along the direction of the slot, and it also may rotate along the direction vertical to the slot relative to the fixing cover.

The fixing cover includes a wrapping portion and a fixing portion located at an edge of the wrapping portion. The wrapping portion has substantially the same radian as the spherical casing to allow the spherical casing to rotate. The fixing portion is used to fix the wrapping portion to the casing. The slot may allow the connecting wire to pass through and prevent the connecting wire from being tangled when the spherical casing rotates along the slot. The simple structure of the spherical casing and the fixing cover makes the product easy to be produced, and when a user operates the handheld electronic device having the built-in structure, the slot of the fixing cover may support a wide angle and polydirectional rotation of the spherical casing. Thus, the image capture angle increases greatly.

These and other features, aspects and advantages of the present invention will become better understood with regard to the following description, appended claims, and accompanying drawings.

### BRIEF DESCRIPTION OF THE DRAWINGS

FIG. 1A and FIG. 1B are exploded diagrams showing the image capture module of the handheld electronic device according to an embodiment of the invention;

FIG. 2A and FIG. 2B are assembly diagrams showing the image capture module of the handheld electronic device in an embodiment of the invention, and the camera module is disposed in the spherical casing;

FIG. 3A and FIG. 3B are assembly diagrams showing the image capture module of the handheld electronic device in an embodiment of the invention, and the spherical casing is disposed in the casing;

FIG. 4A to FIG. 4D are assembly diagrams showing the image capture module of the handheld electronic device in an embodiment of the invention, and the fixing cover is fixed to the spherical casing;

FIG. 5A and FIG. 5B are schematic diagrams showing the left-and-right rotation of the image capture module of the handheld electronic device in an embodiment of the invention;

FIG. 6A and FIG. 6B are schematic diagrams showing the up-and-down rotation of the image capture module of the handheld electronic device in an embodiment of the invention; and

FIG. 7A and FIG. 7B are schematic diagrams showing the applications of the image capture module of the handheld electronic device in an embodiment of the invention.

### DETAILED DESCRIPTION OF THE INVENTION

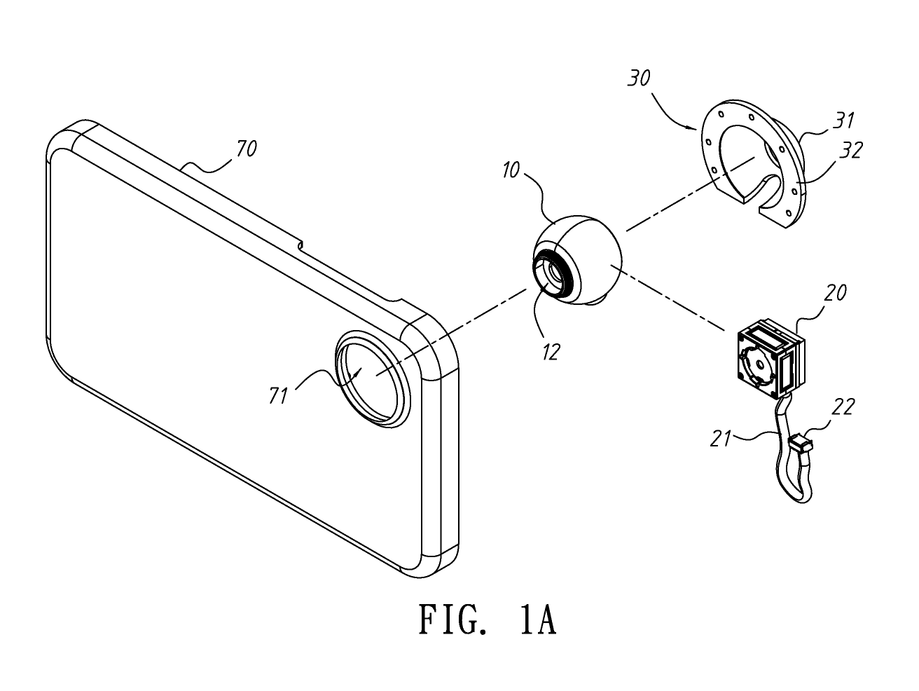

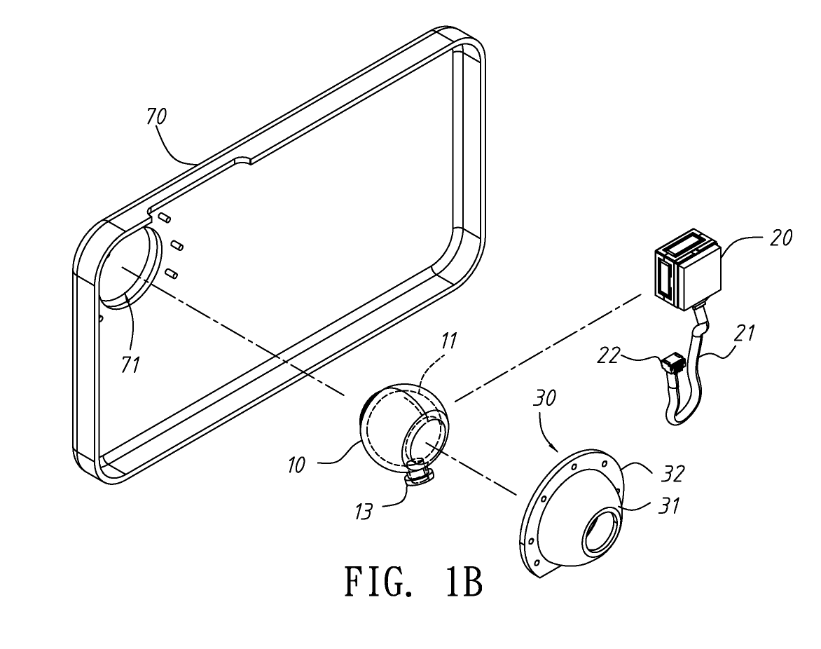

According to an image capture module of a handheld electronic device disclosed in the invention, as shown in FIG. 1A and FIG. 1B, they are exploded diagrams showing the image capture module of the handheld electronic device according to an embodiment of the invention.

The image capture module of the handheld electronic device in the embodiment of the invention includes a spherical casing 10, a camera module 20 and a fixing cover 30 used to be disposed in the casing 70 of the electronic device. The spherical casing 10 is substantially a hollow sphere, and an accommodating space 11 is formed inside. An image capture window 12 passing through the spherical casing 10 is located at a side wall, and the image capture window 12 communicates with the accommodating space 11 inside the spherical casing 10. In addition, a hollow tube 13 is located at the bottom of the spherical casing 10 and communicates with the accommodating space 11.

The casing 70 has an assembling hole 71, and the internal diameter of the assembling hole 71 is slightly smaller than the external diameter of the spherical casing 10 to allow the spherical casing 10 to be disposed inside the casing 70. In addition, the image capture window 12 of the spherical casing 10 corresponds to the assembling hole 71 of the casing 70. Since the internal diameter of the assembling hole 71 is slightly smaller than the external diameter of the spherical casing 10, the spherical casing 10 cannot drop from the assembling hole 71, and only part of the image capture window 12 is exposed out of the casing 70.

The camera module 20 may be a charge coupled device (CCD), a complementary metal-oxide semiconductor (CMOS) and other sensitive electronic devices. It has a connecting wire 21, a connecting plug 22 for electrically connecting to a circuit board of the electronic device is at an end of the connecting wire 21. The camera module 20 is disposed in the accommodating space 11 of the spherical casing 10, and it is disposed correspondingly to the image capture window 12. The user may capture outside images via the image capture window 12. The connecting wire 21 at the bottom may pass through the spherical casing 10 via the hollow tube 13 of the spherical casing 10.

The fixing cover 30 includes a wrapping portion 31 located at the center and a fixing portion 32 at the edge of the wrapping portion 31. The wrapping portion 31 has substantially the same radian as the back of the spherical casing 10, and it may allow the spherical casing 10 to rotate when it is disposed at the spherical casing 10. The fixing portion at the edge is used to fix the fixing cover 30 to the casing 70.

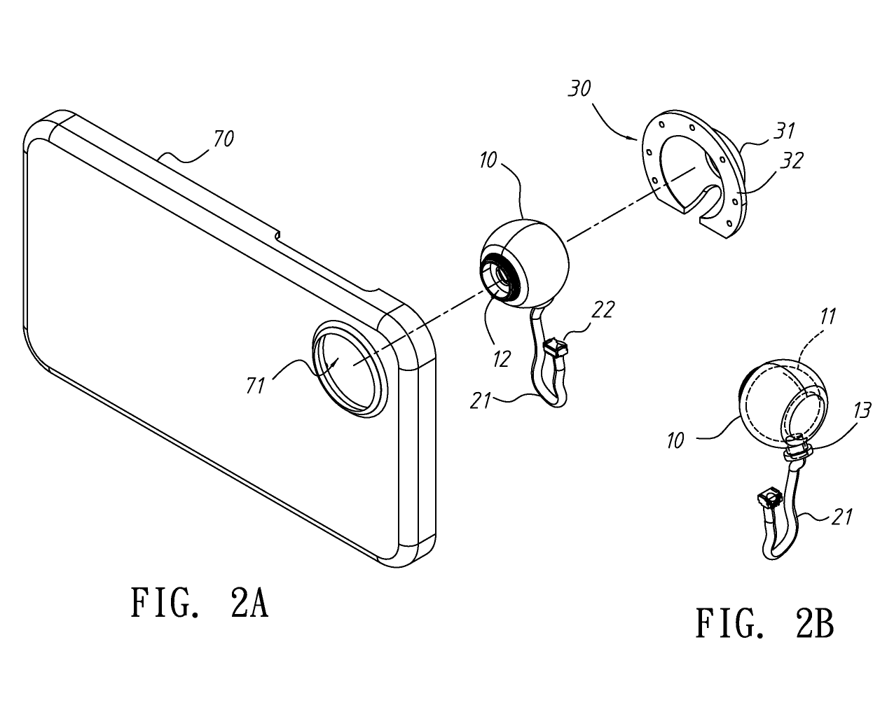

As shown in FIG. 2A and FIG. 2B, they are schematic diagrams showing the assemblies of the image capture module of the handheld electronic device in an embodiment the invention, and the camera module 20 is disposed in the spherical casing 10.

During assembling, the camera module 20 is first disposed in the accommodating space 11 of the spherical casing 10. The spherical casing 10 may have an opening, or it may be bisected or detached in other modes to allow the camera module 20 to be disposed in the accommodating space 11. After the camera module 20 is disposed, to allow the camera module 20 to capture outside images, the position of the camera module 20 needs to coincide with the position of the image capture window 12. The connecting wire 21 passes through the spherical casing 10 via the hollow tube 13 at the bottom of the spherical casing 10.

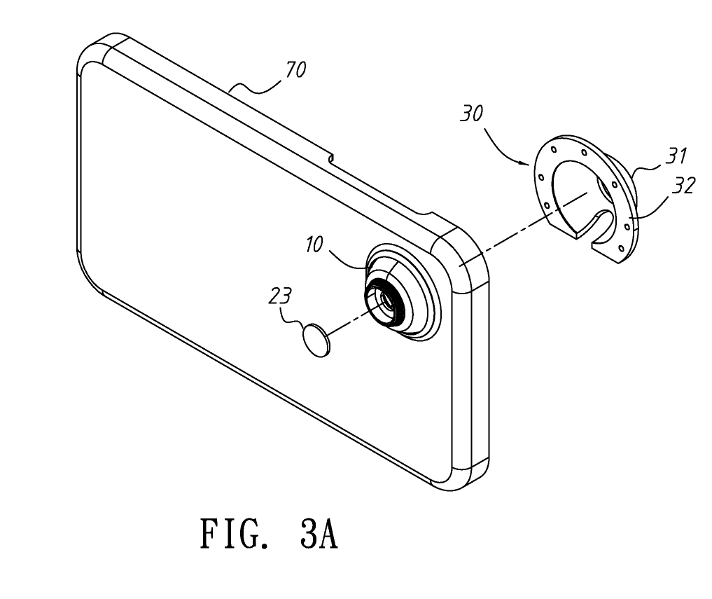

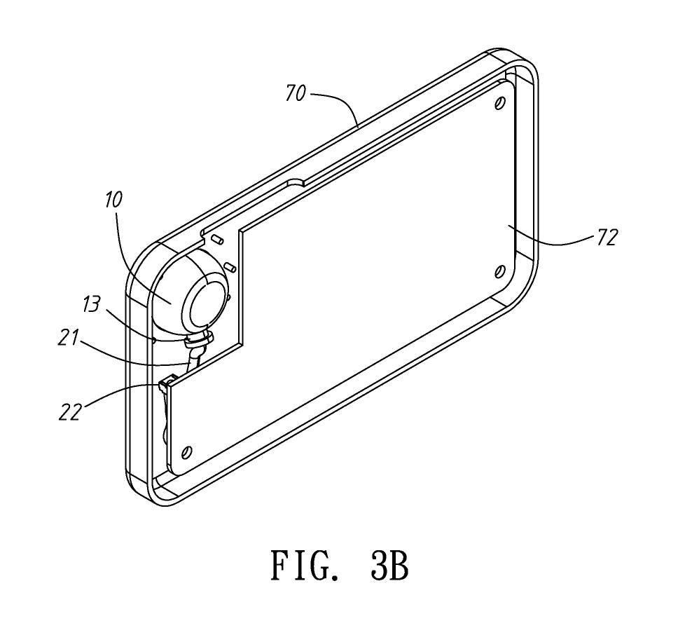

Then, as shown in FIG. 3A, the spherical casing 10 is disposed in the assembling hole 71 of the casing 70 from the inside of the casing 70. Since the external diameter of the spherical casing 10 is greater than the internal diameter of the assembling hole 71, the spherical casing 10 may be disposed in the assembling hole 71 directly and fixed at a proper position to avoid dropping from the casing 70. The position of the image capture window is outward to allow the camera module 20 to capture images. A lens 23 may be disposed at the position of the image capture window 12, and this not only protects the camera module 20, but also increases the image capture efficiency.

As shown in FIG. 3B, the connecting wire 21 at the bottom is electrically connected to the circuit board 72 which is disposed subsequently. Generally, the connecting plug 22 at the end of the connecting wire 21 is plugged into a corresponding outlet on the circuit board 72. Besides, the connecting mode also may be welding. Then, outside images are captured by the camera module 20 under the control of the electronic device.

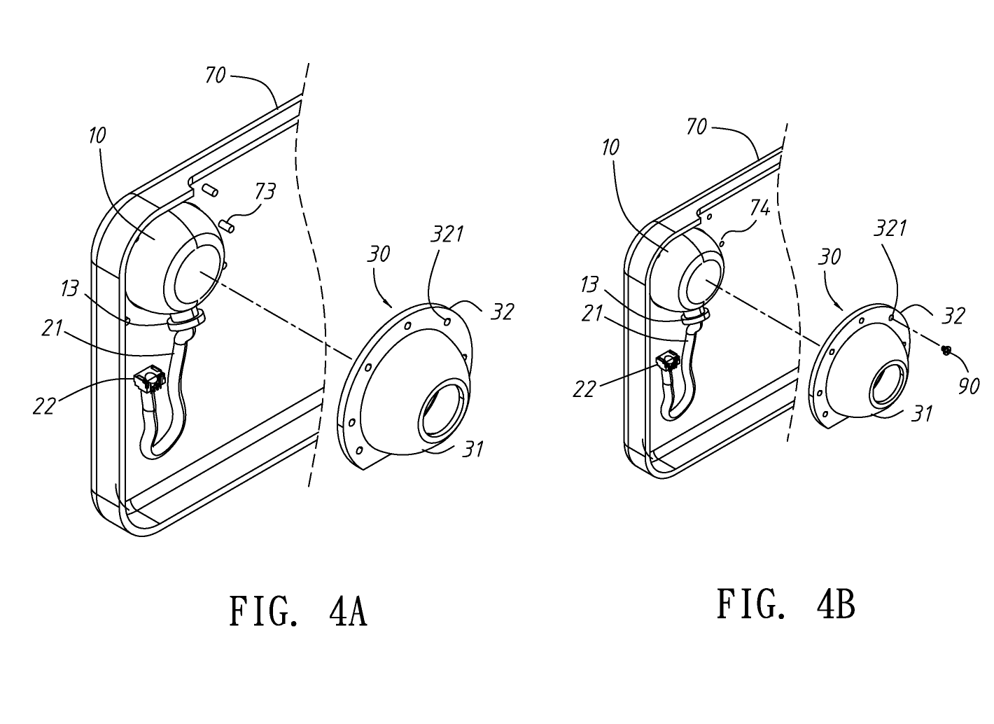

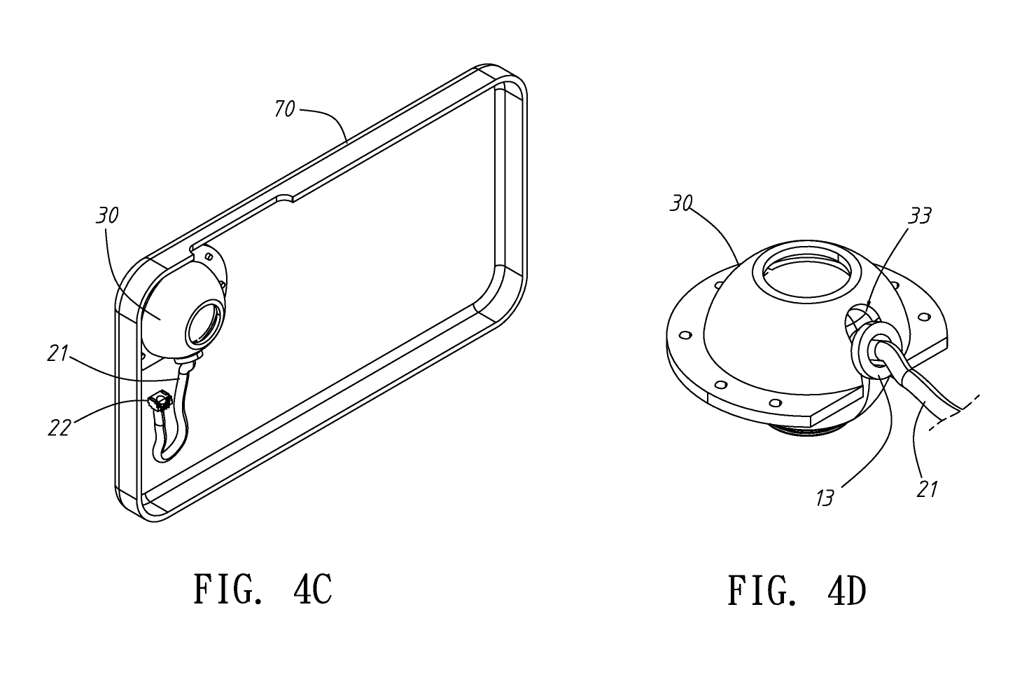

Then, as shown in FIG. 4A, the fixing cover 30 covers the spherical casing 10, and the fixing cover 30 is used to retain and fix the spherical casing 10 on the casing 70 by connecting the fixing portion 32 at the edge and the casing 70. As shown in FIG. 4A, multiple fixing pillars 73 at the casing 70 are fastened with the fixing hole 321 at the fixing portion 32 in a tight fitting mode. If the tight fitting mode is considered to be inadequate, the fixing cover 30 and the casing 70 further may be connected to each other in a heat sealing mode, or the fixing cover 30 even may be fixed to the casing 70 by a screw 90 screwing to the screw hole 74 (as shown in FIG. 4B).

As shown in FIG. 4C and FIG. 4D, since the fixing cover 30 has a slot 33 at the bottom, the connecting wire 21 of the camera module 20 may pass through the slot 33, and the connecting wire 21 is not pressed, and the electrically connection relationship between the circuit board 72 and connecting wire 21 is not affected.

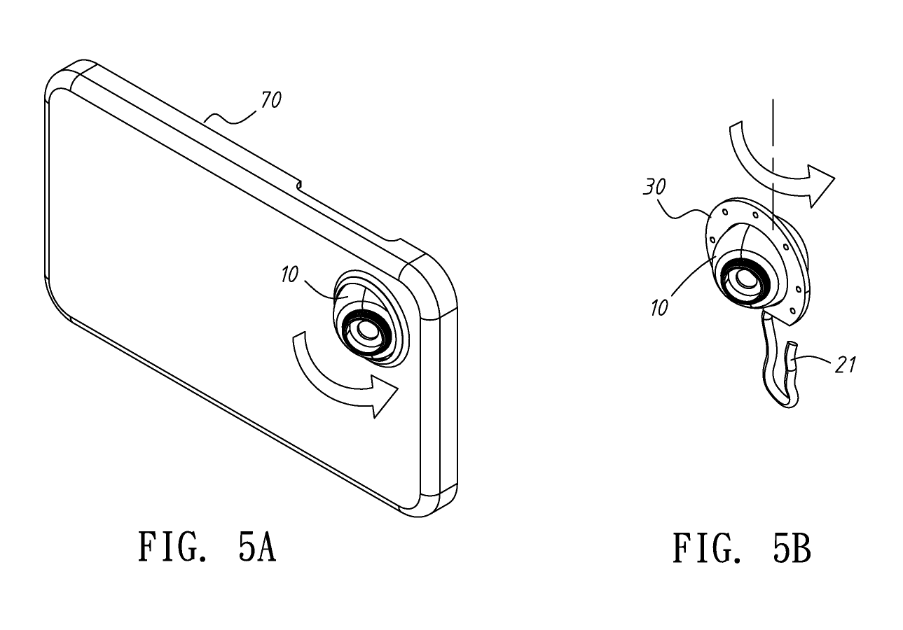

First, as shown in FIG. 5A and FIG. 5B, since the spherical casing 10 is substantially spherical, and the wrapping portion 31 of the fixing cover 30 has substantially the same radian as the back of the spherical casing 10, only the connecting wire 21 at the bottom may limit the rotation of the spherical casing 10. Therefore, the spherical casing 10 may rotate transversely around the hollow tube 13 where the connecting wire 21 is disposed. In other words, it may rotate along the direction vertical to the slot. The rotation direction is described relative to the hollow tube 13, and if the hollow tube 13 is disposed at a side wall, the spherical casing 10 may rotate up and down. The direction is described according to FIG. 5A and FIG. 5B.

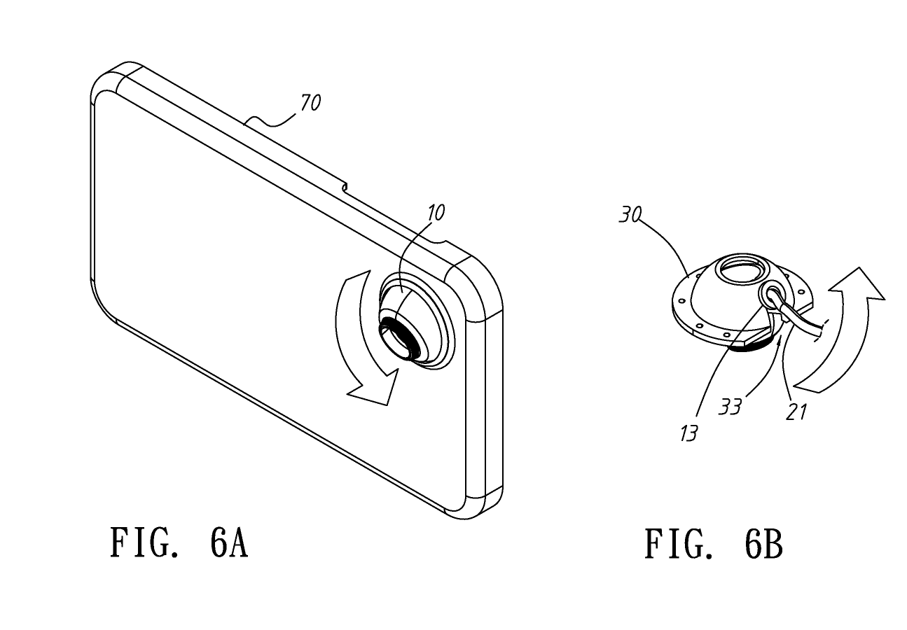

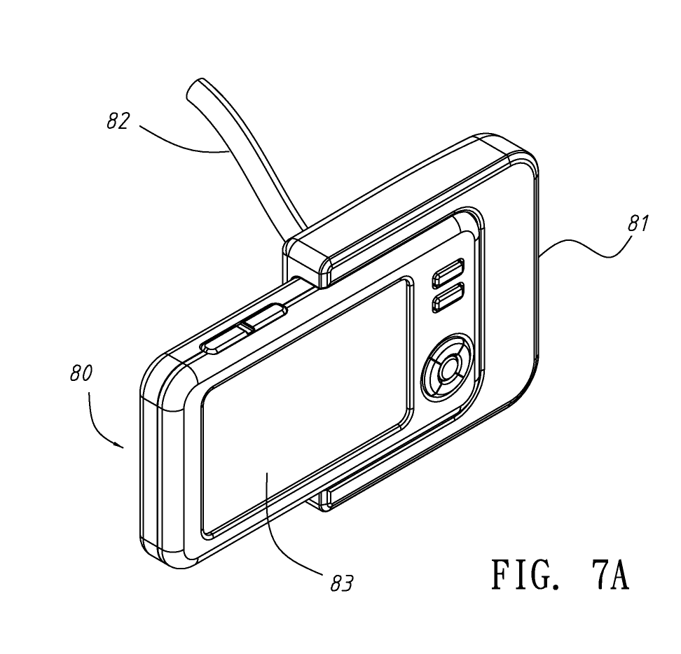

Then, as shown in FIG. 6A and FIG. 6B, since the hollow tube 13 and the connecting wire 21 pass through from the slot 33 of the fixing cover 30, the spherical casing 10 also may rotate up and down along the direction of the major axis of the slot 33 (also shown in FIG. 4D). In other words, with the cooperation of the two rotation directions, and in the plane of the casing 70, the wide angle and polydirectional rotation of the camera module 20 may be achieved.

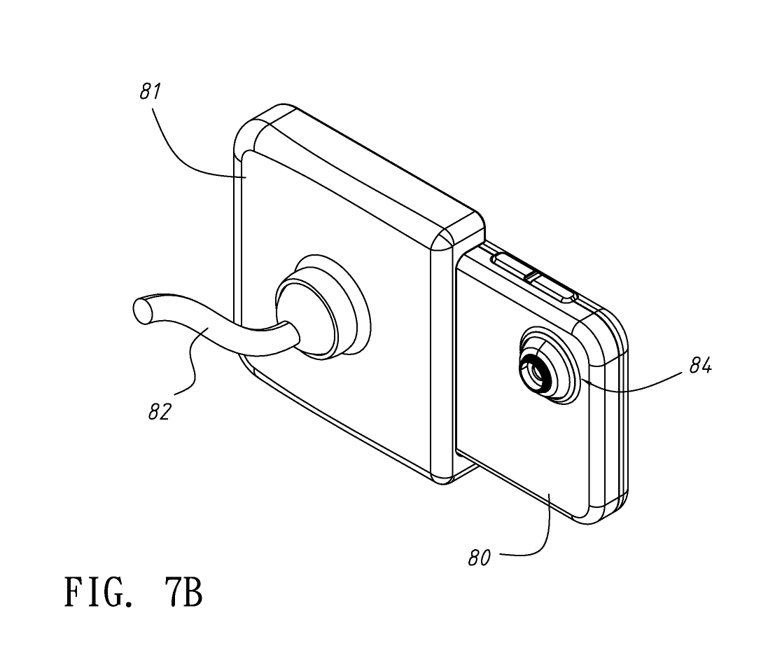

In another aspect, as shown in FIG.7A and FIG. 7B, they are schematic diagrams showing the applications of an image capture module of a handheld electronic device according to an embodiment of the invention.

The image capture module is used in a satellite position system 80 supported by a fixing base 81, and the fixing base 81 is fixed to a windshield of a vehicle using a ball-and-socket type structure connected to a flexible tube 82. The screen 83 of the satellite position system 80 faces inward to make it convenient for the driver to watch. The image capture module 84 in the invention may be disposed outward at the back of the satellite position system 80 to be adjusted to the best angle to record images cooperating with relative software.

In the image capture module of the handheld electronic device in the invention, the spherical casing and the fixing cover cooperate with each other to form a simple structure and provide polydirectional and wide angle rotation to make the image capture module of the handheld electronic device more stable and smooth when it is used. In addition, the image capture module is built-in, and thus the satellite position system does not need to be externally connected with one, and it may be used more smoothly and conveniently.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An image capture module, adapted for an electronic device having a casing with an assembling hole, the image capture module comprising:
a spherical casing disposed inside the casing and having an accommodating space and an image capture window;
a camera module disposed in the accommodating space and having a connecting wire which passes through the spherical casing and is electrically connected to the electronic device; and
a fixing cover covering the spherical casing and fixed on the casing to make the spherical casing retained and fixed at the casing, wherein the fixing cover has a slot to allow the connecting wire to pass through;
wherein the spherical casing rotates along the direction of the slot, and it is also capable of rotating along the direction vertical to the slot relative to the fixing cover.

2. The image capture module according to claim 1, wherein a lens is disposed at the image capture window of the spherical casing.

3. The image capture module according to claim 1, wherein a hollow tube is located at the bottom of the spherical casing to allow the connecting wire to pass through.

4. The image capture module according to claim 1, wherein the fixing cover comprises a wrapping portion and a fixing portion located at the edge of the wrapping portion.

5. The image capture module according to claim 1, wherein the external diameter of the spherical casing is greater than the internal diameter of the assembling hole.
